(19) United States
(12) Patent Application Publication
(10) Pub. No.: US 2016/0272042 A1
(43) Pub. Date: Sep. 22, 2016

(54) Automatic Automotive Air Conditioning System

(71) Applicant: Paul Jensen, Eugene, OR (US)

(72) Inventor: Paul Jensen, Eugene, OR (US)

(21) Appl. No.: 14/942,351

(22) Filed: Nov. 16, 2015

Related U.S. Application Data
(60) Provisional application No. 62/134,080, filed on Mar. 17, 2015.

(51) Int. Cl. B60H 1/00

(52) U.S. Cl. CPC B60H 1/00778; B60H 1/00978; B60H 1/00985; B60H 1/00428

(57) ABSTRACT

An automatic automotive air conditioning system. The present air conditioning system is designed to run on a secondary battery and to have an auditory alarm to alert a user when the battery is below a certain amount of electrical charge or when the temperature is above a certain level. The present air conditioning system includes a secondary battery as a power source, a sensor to detect the interior temperature of the vehicle cabin, and an auditory alarm. The system can additionally include a transmitter to relay the battery and temperature conditions to a mobile electronic device at a distance.

### CROSS REFERENCE TO RELATED APPLICATIONS

This application claims the benefit of U.S. Provisional Application No. 62/134,080 filed on Mar. 17, 2015. The above identified patent application is herein incorporated by reference in its entirety to provide continuity of disclosure.

### BACKGROUND OF THE INVENTION

The present invention relates to automotive air conditioning systems, in particular, to air conditioning systems that are capable of monitoring inside cabin temperature and automatically engaging the air conditioning system to maintain the inside cabin temperature below a threshold temperature.

Summertime brings along more sun and warmer weather. While the more pleasant weather provides for many opportunities to enjoy the outdoors, it also carries along with it some dangers. Once such danger is the significantly increased temperature the inside of a vehicle can reach when left parked outside in the hot weather all day long. Summer temperatures can reach upward of 100 degrees Fahrenheit and the inside of a vehicle can warm up to more than 20 degrees above that. Tragedy can and has occurred when a caregiver accidentally leaves a child or an animal inside of a vehicle at high temperatures for a long enough period to cause injury. This can become particularly dangerous for occupants who are not able to exit a vehicle on their own, such as young children buckled into a car seat or pets left inside a car. Over the last 20 years, more than 600 children have died because of heat stroke from being left in a car. Many more suffer varying forms of heat illness from being left in similar situations.

One approach of ensuring that occupants are kept safe from such incidents is to ensure that the cabin is kept within a safe temperature range. One way of keeping the inside of a vehicle from heating up above the ambient temperature is to leave the windows of the vehicle lowered. This technique leaves the vehicle or the items left inside of it vulnerable to theft. Additionally, this method only ensures the vehicle is kept at the ambient temperature, but is unable to cool the cabin below that. The cabin can be further cooled by using the built-in air conditioning system to lower the interior temperature of the car. However, this method runs the risk of depleting the charge of the car battery, which will not only then fail to keep the air conditioning unit running, but will prevent the car from being able to start. Therefore, there exists a need in the prior art for an air conditioning system that is powered by a secondary battery that can last much longer and that will have no detrimental impact on the vehicle's primary battery to ensure that any occupants of a closed vehicle will be safe from a life threatening heat stroke.

### SUMMARY OF THE INVENTION

In view of the foregoing disadvantages inherent in the known types of automotive air conditioning systems now present in the prior art, the present invention provides an air conditioning system wherein the same can be utilized for providing convenience for the user by running on a secondary battery and having an auditory alarm configured to alert the user when the secondary battery is below a certain amount of electrical charge. The present system comprises an air conditioning system, a secondary battery as a power source, a sensor to detect the temperature of the vehicle interior, and an auditory alarm configured to alert a user when the secondary battery is below a predetermined threshold and when the vehicle cabin is above a predetermined temperature.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic view of an embodiment the invention.

FIG. 2 shows a schematic view of an embodiment the invention with an auditory alarm and a radio transmitter.

FIG. 3 shows a perspective view of the invention installed inside a vehicle.

### DETAILED DESCRIPTION OF THE INVENTION

Reference is made herein to the attached drawings. Like reference numerals are used throughout the drawings to depict like or similar elements of the air conditioning system. For the purposes of presenting a brief and clear description of the present invention, the preferred embodiment will be discussed as used for preventing a vehicle from reaching a dangerous temperature in hot weather. The figures are intended for representative purposes only and should not be considered to be limiting in any respect. As used herein, “logic” refers to (i) logic implemented as computer instructions and/or data within one or more computer processes and/or (ii) logic implemented in electronic circuitry.

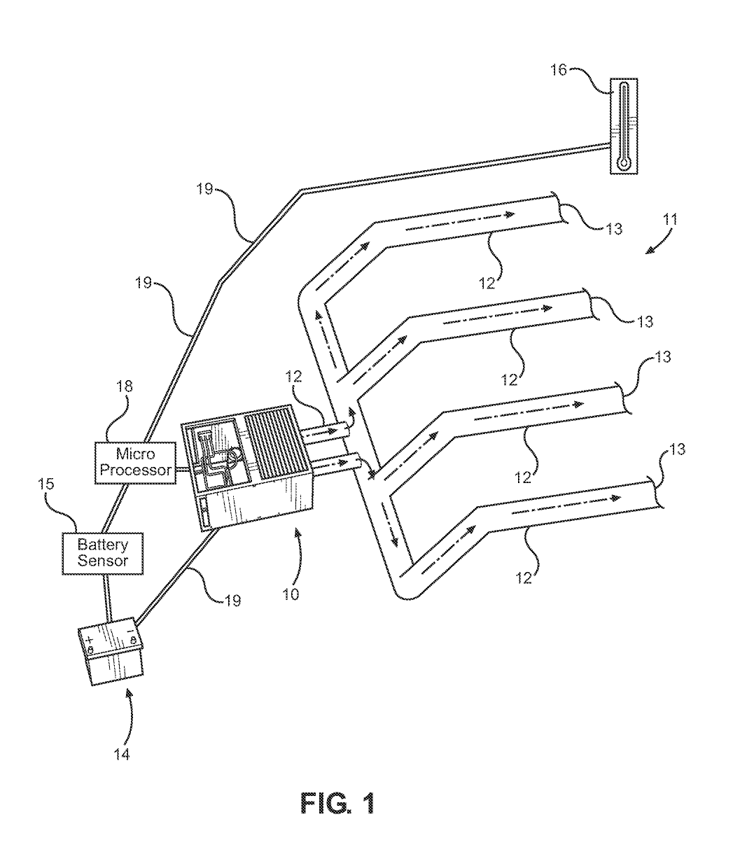

Referring now to FIG. 1, there is shown a schematic view of the invention. An illustrative embodiment of the present invention comprises an air conditioning unit 10 that is known in the prior art, a ventilation system 11, which consisted of a plurality of tubes 12 and vent openings 13, a secondary battery 14, a battery charge sensor 15, a temperature sensor 16, and a logic, wherein the logic in the present embodiment is a microprocessor.

The battery sensor 15 and temperature sensor 16 are operably connected to a microprocessor 18 by means of electrical wiring 19. The microprocessor 18 is configured to control the air conditioning unit 10 in response to the readings of the battery sensor 15 and temperature sensor 16. The temperature sensor 16 relays the current vehicle interior temperature to the microprocessor 18. When the cabin temperature exceeds a threshold temperature, the microprocessor 18 engages the air conditioning unit 10 to begin cooling air and sending the cooled air toward the vehicle interior through the ventilation system.

To ensure that the air conditioning system is run efficiently, the microprocessor can be configured to engage the air conditioning unit at the threshold temperature and continue running until a minimum temperature is reached, which can be lower than that the threshold temperature. When the minimum temperature is reached, the microprocessor 18 deactivates the air conditioning unit 10 until the temperature sensor 16 detects that the threshold temperature is reached once again.

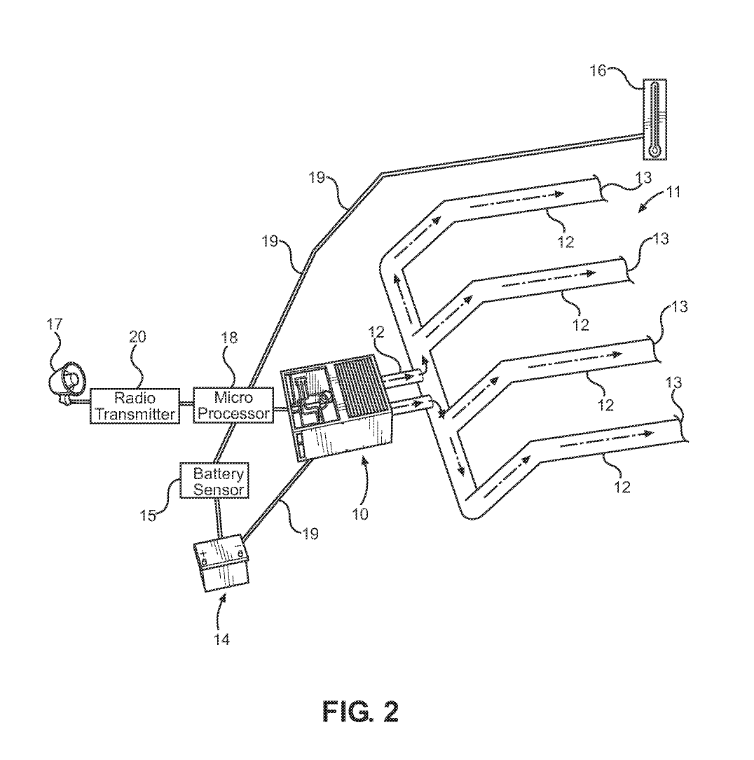

Referring now to FIG. 2, an alternative embodiment of the present invention is shown, where an auditory alarm 17 is operably connected to the microprocessor 18 and mounted inside of the vehicle. When the threshold temperature is reached in the vehicle interior, the auditory alarm is engaged to alert persons nearby that the interior of the vehicle has reached the threshold temperature. In an additional embodiment of the present invention, the auditory alarm is only engaged at a secondary maximum temperature, above the threshold temperature. Additionally, in one embodiment of the present invention a transmitter 20 can be connected to the microprocessor 18, where the microprocessor is configured to emit a wireless signal through the transmitter to a mobile electronic device that is in communication with the transmitter through short-range wireless communication protocol such as Bluetooth. In another embodiment of the invention, the transmitter is in communion with a wireless network through a cell phone tower, and the emitted signal can reach any electronic device that is in communication with the wireless network.

Furthermore, in another embodiment of the invention the microprocessor 18 can be alternatively or additionally configured to indicate, through auditory or wireless signal, when the battery level falls below a predetermined level, based on the reading of the battery sensor 15. For example, when the battery sensor 15 reads a charge of level of less than 10% from the secondary battery 14, the microprocessor 18 is configured to emit a wireless signal to a mobile device through the transmitter 20 that indicates to the user through a text notification that the secondary battery level is low. Alternatively, the microprocessor 18 can be configured to sound the auditory alarm 17 when the secondary battery 14 level is below 10% to alert passersby.

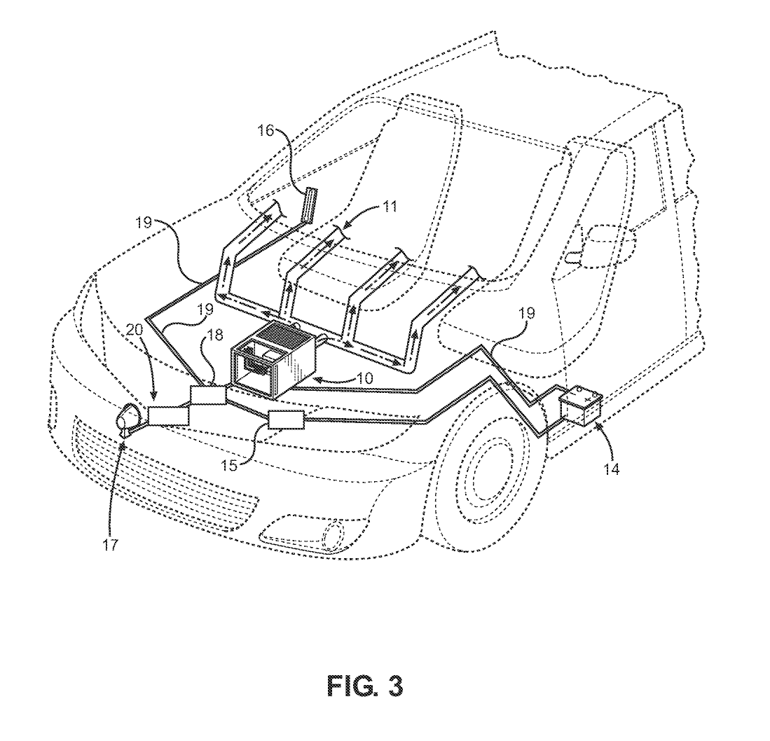

Referring now to FIG. 3, there is shown a perspective view of an embodiment of the present invention within a vehicle. For illustrative purposes only, the vehicle shown in FIG. 3 is an automobile; however, there is no intent to limit the application of the present invention solely to automobiles. In the depicted embodiment of the present invention, the secondary battery 14 is placed in a separate location from the vehicle's primary battery. In most automobiles, the primary battery is disposed within the engine bay; therefore, in this embodiment the secondary battery is disposed at a location other than the engine bay, such as under a seat inside the cabin. The secondary battery 14 may also be placed in other locations, such as in a trunk space or under a central console.

One embodiment of the invention uses a ventilation system 11 that is unique to the invention. In this embodiment, the ventilation ports can be opened, positioned and controlled separately from the existing vehicle ventilation system. This configuration allows for a user to differentiate between how the cooled air of the invention is directed and how the air of the existent heating and cooling system is directed. Another embodiment of the invention uses the ventilation system that is already present in the vehicle from the manufacturer. This embodiment can be a cost saving measure over an embodiment with a separate ventilation system. Additionally, another embodiment of the invention can have multiple secondary batteries. In such embodiments, the microprocessor 18 controls which battery the power input is pulled from and when to switch between batteries.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An air conditioning system for a vehicle, comprising:
an air conditioning unit;
a power source operably connected to the air conditioning unit, wherein the power source is a secondary battery independent from a primary battery of the vehicle;
a temperature sensor configured to detect an interior temperature of the vehicle;
a battery sensor configured to detect a charge level of the secondary battery;
a transmitter;
a logic configured to activate the air conditioning unit when the interior temperature is greater than a threshold temperature and configured to deactivate the air conditioning unit when a minimum temperature is reached.

2) The automotive air condition system of claim 1, further comprising an auditory alarm, wherein the logic is configured to activate the auditory alarm when a maximum temperature is reached.

3) The automotive air conditioning system of claim 1, wherein the logic is configure to transmit a notification to a mobile electronic device via the transmitter when the charge level is less than a threshold charge level.

4) The automotive air conditioning system of claim 1, wherein the logic is configure to transmit a notification to a mobile electronic device via the transmitter when the threshold temperature is reached in the vehicle interior.
